(19) United States
(12) Patent Application Publication
(10) Pub. No.: US 2017/0162929 A1
(43) Pub. Date: Jun. 8, 2017

(54) Charging Cable

(71) Applicant: Maayan Goren, Oranit (IL)

(72) Inventor: Maayan Goren, Oranit (IL)

(21) Appl. No.: 15/327,528

(22) PCT Filed: Jul. 21, 2015
(86) PCT No.: PCT/IL2015/050751

§ 371 Date: Jan. 20, 2017

Related U.S. Application Data
(60) Provisional application No. 62/026,722, filed on Jul. 21, 2014.
(60) Provisional application No. 62/058,691, filed on Oct. 2, 2014.

(51) Int. Cl. H01Q 1/22; H04M 1/725; G06F 1/16; H01B 11/00; H04B 1/18

(52) U.S. Cl. CPC H01Q 1/22; H01B 11/00; H04B 1/18; G06F 1/16; H04M 1/72527

(57) ABSTRACT

The present invention relates to a charging cable utilized to recharge electronic devices while providing seamless backup of data contained in the electronic device.

### FIELD OF THE INVENTION

The present invention relates to a charging cable utilized to recharge electronic devices such as mobile communication devices, and in particular, to such a charging cable capable backing-up the data on the mobile device so as to enable data recovery if needed.

### BACKGROUND OF THE INVENTION

Our daily use of mobile electronic devices has made us greatly dependent on them and the data stored in them, in particular personal data, is therefore made greatly valuable.

Such personal data is vulnerable to loss or theft as it is tied to the mobile electronic device storing the information. Such information generally including personal data, media content, contact information, pictures, sensitive data and is generally very valuable to the individual owner, especially if that data is compromised, lost or stolen.

While individuals can back up the data on mobile devices by linking to other mass storage means such as the cloud, external drives, computers or the like. However, such backups are generally done at intervals that are not on pace with the rate of accumulating new data such as pictures. Furthermore data backup requires users to take an active step to do so. Therefore generally backed up data generally tends to be out of date as it is generally not done on a regular and/or daily basis.

The lack of a daily backup routine leaves the data in particular personal data vulnerable and/or susceptible such that it may be irreplaceably lost should the electronic device become lost, stolen or irreparably damaged.

While automatic backup solutions are available utilizing software solutions, however, such solutions still require the user to take an active part to enable the backing up process.

Other solutions such as that described in US Patent Publication No. US2014032943A1 to Goel discloses a cable for providing electric power from a power source to a mobile device, wherein the cable comprises a memory module for backup and bidirectional transfer of data to and from the mobile device.

### SUMMARY OF THE INVENTION

The background art provides software backup solutions as well as devices such as charging cable capable of backing up a device that is connected to it.

However, currently available charging cables are bulky as the electronic circuitry providing the backup functions are provided in housing distinct from the charging cable itself. Furthermore, the background art does not provide a charging cable capable of simultaneously charging and backing more than one electronic device.

The present invention overcomes the deficiencies of the background by providing a charging cable that is capable of backing up a plurality of devices simultaneously by utilizing a communication antenna that may be embedded and/or integrated with the charging cable. Such that the charging cable according to embodiments of the present invention acts as a charging cable, a seamless backup device to a plurality of devices by utilizing an integrated communication antenna provided to facilitate data exchange between memory stores associated with cable and associated electronic devices. The device according to the present invention further provides a low profile device that assumes the form of a regular recharging cable having two dedicated ends.

Preferably, the backup process is automatically performed as a background function of the charging cable when connected to a mains power supply and associated with an electronic device to be backed up.

Preferably the functions of the charging cable and its backup function may be controllable with a dedicated software application and/or app running on an electronic communication device. Optionally backup process may be initiated at any time by way of utilizing a dedicated software application and/or app running on an electrical device associated with the charging cable. Optionally the backup process is not dependent on the re-charging process and may be initiated at any time when the recharging cable is supplied with sufficient power.

Optionally the charging cable may be provided with at least one or more controllable user interface, for example a button, so as to allow a user to control the use of the recharging cable directly from the cable itself.

Preferably the charging cable may be functionally associated with at least one electronic device comprising data by way of a wired connection, such as a dedicated connector at an end of the cable, or by way of wireless connection utilizing an embedded antenna.

Within the context of this application the term electronic device may interchangeably refer to any one or more of mobile phone, smart phone, PDA, tablet computer, mobile computer, desktop computer, smart watch, mass storage device, the like or any combination thereof.

Within the context of this application the term electronic power source may interchangeably refer to any device capable of acting as a power source for recharging an electronic device. Such electronic power sources may for example including but is not limited to battery, vehicle power, mains power, transformer, induction charging pad, wireless charging pad, generator, photovoltaic cells, the like or any combination thereof.

Unless otherwise defined the various embodiment of the present invention may be provided to an end user in a plurality of formats, platforms, and may be outputted to at least one of a computer readable memory, a computer display device, and a printout, a computer on a network or a user.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustrative diagram of an exemplary device according to the present invention;

FIG. 2 is a schematic illustrative diagram of an exemplary device according to the present invention; and

FIG. 3 is a schematic block diagram of the circuitry utilized with an exemplary device according to the present invention;

### DESCRIPTION OF THE PREFERRED EMBODIMENTS

The principles and operation of the present invention may be better understood with reference to the drawings and the accompanying description.

The following figure reference labels are used throughout the description to refer to similarly functioning components are used throughout the specification hereinbelow.

10,11 Electronic Device;

20 Power Source;

100,101 charging cable;

102 conducting wire segment

104 antenna portion;

105 antenna;

106 magnetic core

108 directional antenna pin;

110 first end;

112 first end connector housing

120 second end;

122 second end connector housing;

130 circuitry;

132 controller module;

134 memory module;

135 power module;

136 communication module;

138 user interface;

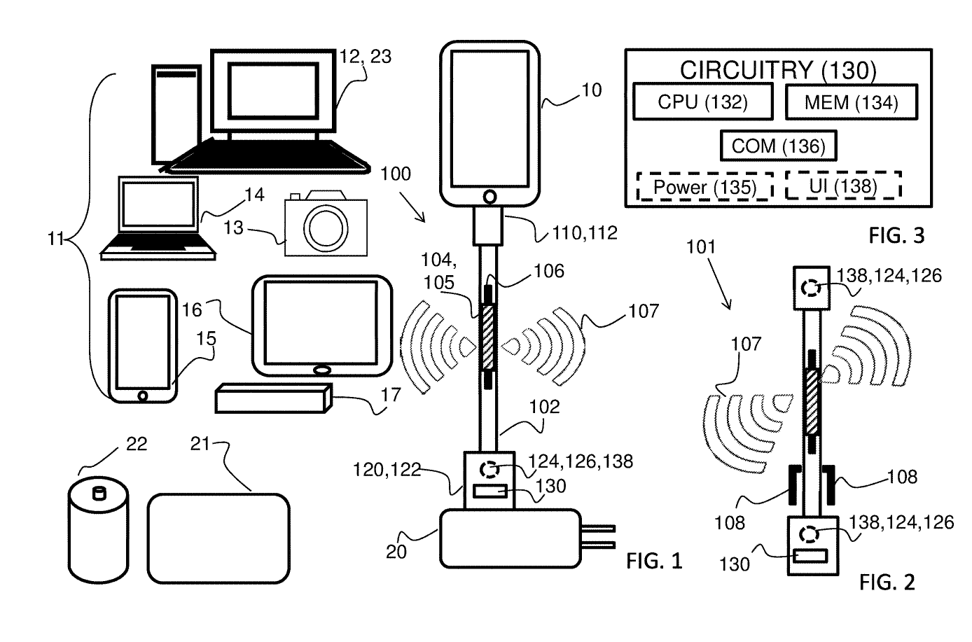

Referring now to the drawings, FIG. 1 is a schematic illustrative diagram of a charging cable 100 according to the present invention. Charging cable 100 provides a charging cable that is configured to provide seamless data backup and recovery point for a plurality of electronic devices that are associated with cable 100.

Cable 100 may be functionally associated with a first electrical device 10, for example a mobile communication device by way of wired coupling and functionally associated with a second electrical device 11, for example including but not limited to a camera 13 and/or computer 12,14, tablet 16, smart watch (not shown) mobile communication device 15, mass storage device 17 any combination thereof or the like, by way of wireless coupling via wireless communication antenna 105 configured to transmit and receive 107 data from the second electrical device 11.

Accordingly antenna 105 provides for facilitating simultaneously creating a data backup of at least two or more electrical devices 10, 11.

Optionally cable 100 utilizing communication antenna 105 therein may further provide for transferring data between any electrical device 10, 11 associate with cable 100.

For example, while a backup of mobile communication device 10 is seamlessly performed with cable 100 via electronic circuitry 130, data from camera 13 may be transferred to stores in either or both of cable 100, computer 12,14, tablet 16, mobile communication device 15, mass storage device 17 or the like.

Cable 100 may facilitate the process of downloading data onto a device, for example mobile communication device 10, by providing a secondary processor provided as part of circuitry 130, as will be described in greater detail.

Most preferably seamless data backup is provided when cable 100 is coupled to an optional power source device 20, for example including but not limited to mains power, mains power transformer, battery 22, vehicle, wireless charging pad 21, induction charging pad 21, the like or any combination thereof.

Preferably the functions of the charging cable 100 is controllable with a dedicated software application and/or app running on at least one electronic device 10 that is associated with cable 100.

Optionally charging cable 100 may be controllable with user interface controllers 124,126 for example provided in the form of buttons or sense pads that may be disposed along an end 120, 110 of the charging cable 100.

Preferably charging cable 100 includes an electrically conducting segment 102 provided for electrical conduction along its length between a first end 110 and a second end 120. Cable 100 is characterized in that cable segment 102 comprises an embedded antenna 105 along at least a portion 104 of segment 102 and electronic circuitry 130 disposed about at least one cable end 110,120, more preferably second end 120.

Cable first end 110 provides for associated with optional electronic devices 10 and is fit with a connector 112 for coupling first end 110 to an optional electronic device 10 that is to be charged and seamlessly backed up.

Optionally first end 110 may be provided with at least two or more first end connectors 112, for example to facilitate wired coupling between cable 110 and at least two devices 10 each having a dedicated connector 112 having the same or different connector type.

Optionally first end connector 110 may optionally be coupled to a wireless charging pad 22 or the like intermediate device that is functionally coupled to an electronic device 10.

Connector 112 may assume any form as is known in the art that is capable of connecting to an electronic device. Connector 112 may for example be provided in the form of USB, USB 2.0, USB 3.0, micro-USB, USB-OTG, mini-USB, USB type A, USB type B, firewire, IEEE 1394 IEEE1394a, IEEE1394b, lightning, or the like connector as is known in the art with any number of connecting pins.

Cable second end 120 is fit with a connector 122 configured for coupling to a charging power source 20. Most preferably second end connector 122 is configured to include electronic circuitry 130 for controlling cable 100.

Most preferably connector 122 is provided in the form of a Universal Serial Bus (‘USB’) connector or the like. Optionally connector 122 may be provided in optional forms that are capable of connecting to any power source devices 20 as is known in the art. For example power source device 20 may be provided with any direct current (DC) plug or the like connector having charging pins.

Optionally first end connector 112 and/or second end connector 122 may be further fit with a platform for connecting an external flash memory storage device in optional forms for example including but not limited to a memory card, dongle, USB key or the like.

As shown in greater detail in FIG. 3, electronic circuitry 130 includes circuitry for controlling and rendering cable 100 functional as a charging cable and a backup device. Preferably circuitry 130 includes a controller module 132, memory module 134, and communication module 136. Optionally circuitry 130 may further comprise power module 135. Optionally circuitry 130 may further comprise a user interface module 138.

More preferably circuitry 130 is disposed within second end 120 connector 122 housing. Optionally circuitry 130 may be disposed at first end 110 within the connector 112 housing. Optionally circuitry 130 may be disposed on both first end connector 112 and second end connector 122, wherein the different modules may be split between the first end connector 112 and second end connector 122.

Optionally circuitry 130 includes an antenna matching circuit to match the impedance of the charging cable to that of the transmitter.

Controller module 132 comprises a microprocessor or the like electronics for controlling the different modules utilized with circuitry 130 and to control processing data, backup functions, facilitate connection and/or association with at least one or more electronic device 10, 11.

Optionally controller module 132 may be utilized as a parallel processing tool for facilitating data processing that is being performed in any electronic device 10,11 associated with cable 100. For example controller module 132 may be utilized to assist a first electronic device 10 or a secondary electronic device 11 to downloading data that is processing heavy.

Memory module 134 provides a data stores for storing data communicated to cable 100. Optionally memory module 134 may be provided in any form for example including but not limited to ROM, RAM, Volatile memory, Flash memory, EEPROM, SD Card, the like electronic memory device or circuity, or any combination thereof.

Communication module 136 is preferably provided in the form of an electromagnetic wireless communication module and/or an optical communication module capable of running any wireless communication protocols for example including but not limited to IEEE802.11, WiFi, IEEE1701-2011, Bluetooth, Near Field Communication (NFC), any combination thereof, or the like as is known in the art. Therein module 136 provides wireless communication functionality to cable 100. Optionally communication module 136 may comprise a wireless antenna circuitry therein providing a wireless communication antenna that may be utilized to communication with at least one or more electronic devices 10, 11.

Optional power module 135 may comprise circuitry for controlling the power supply internal to circuitry 130 and its modules. Preferably power module 135 does not act as direct power source for charging an electronic devices 10.

Optionally circuitry 130 and in particular controller module 132 may be utilized to perform a power source pre-use functionality test of power source 20 coupled with cable 100. Such a test may be implemented so as to ensure that power source 20 will functions properly with at least one or more devices 10,11 that are associated thereto. Preferably such pre-use performance test is used to confirm that the power source device 20 will not harm any of the devices 10, 11 associated thereto. For example, such a test may be utilized to identify power source parameters 20 for example including but not limited to power supply specification, power supply voltage accuracy, maximum charging current, any combination thereof or the like. Preferably the results of the pre-use functionality test may be communicated and/or conveyed to the user via UI module 138 for example in the form of an indicator light (LED) and/or display message, or the like.

Cable 100 may optionally feature a user interface (UI) module 138 that may be provided in optional forms. UI module 138 is capable of interfacing with a user in optional forms, for example including but not limited to a button 124, switch, display, LED indicator 126, sense pad 124, touch pad, speaker, or the like. Preferably UI module 138 may be integrated with the housing of circuitry 130. UI module 138 is functionally associated with circuitry module 130 and disposed along at least one of or both of first end connector 112 and/or second end connector 122.

Optionally user interface 138 may be realized as a user control interface 124, 126 for example in the form selected from the group comprising: button, switch, analog switch, digital switch, sense pad, touch pad, the like or any combination thereof. Such a control interface may be disposed along a surface of one of first end connector 112 or more preferably second end connector 122, for example as shown in the form of touch pad 124 or indicated 126. Control interface 124, 126, for example in the form of an analog switch, may be utilized to control the internal functions of at least one or more electronic devices 10, 11 that are associated with cable 100,101. For example, a touch pad 124 or analog switch may be configured to be utilized as an on/off switch for a camera 13 when associated with cable 100. A control interface 124 utilized as part of interface module 138 may optionally be utilized to select functionality modes of cable 100,101 for example including but not limited to controlling running speed, speed of backup, synchronization functions, connection speed, select functional modes, to allow a user to select how and which electronic devices 10, 11 are functionally coupled with cable 100,101, any combination thereof or the like functions.

Optionally first end connector 112 and/or second end connector 122 may further feature a user interface sensor (not shown) associate with UI module 138. User interface sensor 124, 126 may for example include but is not limited to a sensor taking the form of a touch pad, button, touch pad matrix, or the like touch sensitive device. Preferably such a user interface sensor provides for identifying user's intent to disconnect and/or remove and/or disassociate cable 100 from device 10 at first end connector 112 to generate a disconnection signal that is conveyed to processing module 132. Preferably when such a disconnection signal is generated the backup process may be properly adjusted and/or stopped and/or put on hold so as to not jeopardize the backup process at large. Optionally when such a removal signal is generated, processing module 132 may determine to continue the backup process in a wireless manner via antenna 105.

Optionally user interface 138 may additionally be realized as an information interface where information is conveyed to a user the status of the backup process. Such informational user interface may for example be provided in the form selected from the group comprising: display, LED indicator, speaker, the like or any combination thereof.

Preferably cable 100 is characterized in that at least a portion 104 of conducting segment 102 is configured to form a communication antenna 105. Portion 104 forming antenna 105 may be disposed anywhere along the length of segment 102 for example including but not limited to adjacent to first end 110, adjacent to second end 120 or a portion along the length of segment 102, midway along the length of segment 102, or disposed along the full length of segment 102, any combination thereof or the like.

Optionally and preferably antenna 105 is functionally coupled with said circuitry (130) most preferably with communication module 136. Preferably antenna 105 provides for transmitting and receiving data as schematically shown with transmission lines 107.

Optionally and preferably cable 100 may be functionally coupled at second end 120 with any power source 20. Power source device 20 may be any power source device for example including but not limited to a mains power, mains power transformer, mains power adapter, battery 22, vehicle power, mains power, transformer, induction charging pad 21, wireless charging pad 21, generator, photovoltaic cells, the like or any combination thereof.

Preferably cable 100 may be functionally coupled at first end 110 with any electronic device 10 and wirelessly coupled with at least one or more additional electronic device 11 so as to enable cable 100 to backup any electronic device 10 that it is associated with. Electronic device 10, 11 may be any electronic device for example including but not limited to mobile phone 15, smart phone 15, PDA, tablet computer 16, mobile computer 14, desktop computer 12, mass storage device 17, camera 13, smart watch the like or any combination thereof.

Cable 100 may be coupled to a plurality of electronic devices a first device 10 and at least one secondary device 11 to allow undertaking backup data disposed on all devices 10, 11 associated with cable 100. Most preferably first device 10 is functionally associated with cable 100 over first end connector 112 while at least one or more secondary devices 11 is wirelessly functionally coupled with cable 100 utilizing antenna 105 embedded along antenna portion 104 of conducting segment 102.

Antenna 105 may be formed by way of looping conducing wire along antenna portion 104 of conducing segment 102.

Antenna portion 104 may optionally be further fit with a magnet 106 or the like magnetic materials having magnetic properties to facilitate forming communication antenna 105. Optionally a wire coil may be looped around the length of magnet 106 to form antenna 105.

As shown in FIG. 2 an optional embodiment of the charging cable according to the present invention that is similar to cable 100 depicted in FIG. 1, charging cable 101 further featuring at least one or more controllable directional antenna pins 108 provided to provide antenna 105 with directionality of the antenna's transmission 107. Preferably the position and/or length of pins 108 may be controlled relative to cable 100. Pins 108 may optionally be configured to be telescopic so as to control its length and may assume a long or short configuration.

Preferably antenna 105 provides for maximizing utilization of processing power of processing module 132 to facilitate downloading data to and/or from any device 10,11 that is associated with cable 100,101. For example, a processing heavy download, such a game and/or movie may be facilitated with cable 100,101 as the download process may be optimized by undertaking parallel and/or simultaneously process by the device 10,11 own processing while utilizing processing module 132 to speed up the process of computing of at least one or more electronic device 10, 11. Parallel data processing may be carried out with processing module 132 along with the processors of at least one or more electronic device 10,11 coupled thereto so as to allow for handling large data. For example , cable 100 may facilitate processing large data such as compressing a video file, by allowing for sharing the processing workload between processing module 132 and at least one or more electronic devices 10,11 that are associated with cable 100, to greatly reduce the overall processing time.

Optionally user interface module 138 and in particular a control interface 124,126 may be utilized to select functionality modes of cable 100,101 for example including but not limited to running speed, speed of backup, synchronization functions, connection speed, select functional modes, select how and which electronic devices 10,11 are functionally coupled with cable 100,101. For example, user interface module 138 may be provided with an analog switch so as to facilitate functionally control of cable

Optionally user interface module 138 and in particular a control interface may be utilized to facilitate interfacing with a controlling software to control the functionality of cable 100,101.

Optionally cable 101,100 may utilize a touch pad user interface 138 to facilitate control of cable 100, 101 for example as an indicator of expected end time. For example, a charger cable 100,101 connected as shown in FIG. 1 with at least one electronic device 10 may initiate ending backup process when a user's touch is sensed with a user interface 138 touch pad as a sensed touch may indicate the intention of a user to remove the cable.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Citation or identification of any reference in this application shall not be construed as an admission that such reference is available as prior art to the invention.

While the invention has been described with respect to a limited number of embodiments, it will be appreciated that many variations, modifications and other applications of the invention may be made.

1-19. (canceled)

20) A charging cable for charging electronic devices, the cable including;
a) an electrically conducting wire segment provided for electrical conduction between a first end and a second end;
b) wherein said first end is provided in the form of a connector for coupling said cable to an electronic device to be charged;
c) wherein said a second end is provided in the form of a connector that is configured for coupling to a power source device; and
d) circuitry having a controller module, memory module, and communication module; and wherein said communication module having an integrated wireless communication antenna configured to simultaneously communicate with at least one or more electronic devices utilizing wireless communication protocols.

21) The charging cable of claim 20 wherein said circuitry is functionally associated with a user interface.

22) The charging cable of claim 21 wherein said user interface is provided in the form of a control interface selected from: button, switch, analog switch, digital switch, sense pad, touch pad, touch pad matrix, touch sensitive device or any combination thereof.

23) The charging cable of claim 21 wherein said user interface is provided in the form selected from the group consisting of: display, LED indicator, speaker, or any combination thereof.

24) The charging cable of claim 21 wherein said user interface is disposed along at least one of: first end connector or second end connector.

25) The cable of claim 20 wherein said circuitry includes an antenna matching circuit to match the impedance of the charging cable to that of the transmitter.

26) The charging cable of claim 20 wherein said communication module provides wireless coupling with at least one or more electronic devices, wherein said wireless coupling facilitates communication and data exchange with the at least one or more associated electronic devices for rendering a data backup or recovery point of the associated electronic devices, and wherein the data backup or recovery point is stored on said memory module.

27) The charging cable of claim 20 wherein said memory further provides for rendering a data backup or a recovery point for a plurality of electronic devices associated with said charging cable, wherein said memory module is utilized for storing the backup data or recovery point data.

28) The charging cable of claim 27 wherein the recovery point data or backup data is encrypted.

29) The charging cable of claim 20 wherein said power source is selected from: battery, vehicle power, mains power, transformer, induction charging pad, wireless charging pad, generator, photovoltaic cells, any combination thereof.

30) The charging cable of claim 20 wherein said connector are selected from a Universal Serial Bus (‘USB’) connector, USB 2.0, USB 3.0, micro-USB, USB-OTG, mini-USB, USB type A, USB type B, USB type C, firewire, IEEE 1394 IEEE1394a, IEEE1394b, lightning or a magnetic contact.

31) The charging cable of claim 20 wherein first end connector is coupled to a wireless charging pad that is functionally coupled to an electronic device.

32) The charging cable of claim 20 wherein said controller module provides for secondary data processing of wired or wirelessly associated devices.

33) The charging cable of claim 20 wherein at least one of said first end connector or second end connector are further fit with a platform for connecting an external flash memory storage device.

34) The charging cable of claim 20 wherein said communication module is provided in the form selected from an electromagnetic wireless communication module, an optical communication module, wherein there communication modules are capable of running any wireless communication protocols.

35) The charging cable of claim 20 wherein said controller module performs a pre-use functionality to test parameters of devices connected therewith.

36) The charging cable of claim 35 wherein the test parameters include: power supply specification, power supply voltage accuracy, maximum charging current, any combination thereof or the like.

37) The charging cable of claim 20 provided with at least two or more first end connectors.

38) The charging cable of claim 20 wherein said circuitry is disposed on: said first end or said second end, or split between both said first end and said second end.

39) The charging cable of claim 20 configured to be controllable with dedicated software running on at least one electronic communication device associated therewith.

40) The charging cable of claim 20 wherein at least a portion of said wire segment is configured to form a communication antenna wherein said antenna is functionally coupled with said communication module of said circuitry and wherein said antenna is provided in the form selected from: wire segment comprising a magnetic core or a wire segment having looping conducting wire.
